(19) United States
(12) Patent Application Publication
(10) Pub. No.: US 2003/0025439 A1
(43) Pub. Date: Feb. 6, 2003

(54) Glass funnel for a cathode ray tube and cathode ray tube

(75) Inventor: Kenji Fujita, Chiba (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: ASAHI GLASS COMPANY, LIMITED, Tokyo (JP)

(21) Appl. No.: 10/192,077

(22) Filed: Jul. 11, 2002

(30) Foreign Application Priority Data
Jul. 12, 2001 (JP) 2001-212377

(51) Int. Cl. H01J 31/00

(52) U.S. Cl. 313/477 R

(57) ABSTRACT

There is provided a glass funnel for a cathode ray tube, comprising an open end portion having long sides, short sides and corner portions; a neck portion for housing an electron gun therein; a yoke portion for mounting a deflection coil thereto; and a body portion extending between the open end portion and the yoke portion; wherein the long or short sides of the open end portion or the long and short sides of the open end portion have flange portions formed thereon, and the corner portions have no flange portion formed thereon.

### CROSS-REFERENCE TO RELATED APPLICATIONS

The present application claims a priority under 35 U.S.C. §119 to Japanese Patent Application No. 2001-212377, filed on Jul. 12, 2001 and entitled “GLASS FUNNEL FOR A CATHODE RAY TUBE AND CATHODE RAY TUBE”. The contents of the application are incorporated herein by reference in their entirety.

### BACKGROUND OF THE INVENTION

1. Field of the Invention

The present invention relates to a glass funnel for a cathode ray tube and a cathode ray tube, which is mainly utilized in a television broadcasting receiver (hereinbelow, referred as to a TV set) or an information display for industrial purposes.

2. Discussion of Background

As shown in FIG. 6, a cathode ray tube includes an vacuum envelope, which is a glass bulb (hereinbelow, referred as to the bulb) comprising a glass panel for displaying an image (hereinbelow, referred as to the panel) 1 and a glass funnel having a cylindrical neck portion 3 for housing an electron gun 2 therein (hereinbelow, referred as to the funnel) 4.

The funnel 4 mainly comprises a yoke portion 6 for mounting a deflection coil 5 thereto, a body portion 9 extending from an open end portion 8 having a seal edge 7 to be sealed to the panel 1 and merging into the yoke portion 6. The panel 1 and the open end portion 8 of the funnel 4 have both seal edges 7 bonded with, e.g., solder glass to form a sealing portion. Symbol A designates a bulb axis, which connects the central axis of the neck portion 3 and the center of the panel 1. In FIG. 6, the cathode ray tube has only a right half portion shown with a left half portion omitted since the cathode ray tube has a symmetrical structure with respect to the bulb axis A.

The open end portion 8 has an open end formed in a substantially rectangular shape that comprises two long sides 11, two short sides 12, and four corner portions 13 connecting a long side and a short side as shown in FIG. 7.

The funnel or the cathode ray tube is held or carried by several sorts of conveyance equipment in the production process and is moved there, being turned or swung. In comparison with the long sides and the short sides of the funnel open end portion formed in a linear shape, there is a good possibility that the corners collides with devices or equipment in the vicinity of the conveyance path during conveyance, since the corner portions are formed in a convex shape and are located at diagonal positions having the greatest open size. Additionally, there has been created a problem that the corner portions are likely to be fractured at the time of collision.

On the other hand, lightweight displays, such as a plasma display or a liquid crystal display, have been gradually spread for recent years. Since a TV set utilizing a cathode ray tube is heavier than these displays, it has been demanded that the TV set can reduce the weight.

Although the reduction in the weight of the funnel is normally done by decreasing the wall thickness of glass, the reduction in the weight of the glass without any other measure leads to low rigidity of the funnel, creating a problem that the possibility of fracture increases in the production process as stated earlier.

Specifically, there are two typical conventional methods for decreasing the wall thickness of the funnel as examples. The first decreasing method is to modify an inner surface shape of the body portion, and the second decreasing method is to modify an outer surface shape of the body portion.

A glass product for a cathode ray tube is normally produced by press molding. In the case of the first decreasing method, i.e., the method to form the body portion in a shape as shown in FIG. 8(a) by modifying only the inner surface shape of the body portion to decrease the wall thickness and providing the open end portion 8 with a conventional wall thickness for the purpose of modifying the inner surface shape to thin the funnel 4, it is impossible to release the funnel from the mold after press molding. From this viewpoint, it is necessary to decrease the wall thickness of the open end portion 8 as well, as shown in FIG. 8(b). However, the decrease in the wall thickness of the open end portion 8 lowers rigidity, creating a problem that the funnel is likely to be fractured if it is shocked. Additionally, it is necessary to modify the wall thickness of a portion of the seal edge close to the panel 1 as well since the edge of the open end portion 8, i.e., the seal edge 7 is sealed to the panel 1.

On the other hand, in the case of the second decreasing method, the method to modify the outer surface shape of the funnel 4 so as to reduce the weight as shown in FIG. 1, it is preferable, from the viewpoint of a decrease in tensile stress caused at the sealing portion (vacuum tensile stress at the sealing portion) at the time of evacuating the inner portion of the bulb and easy release of the glass product from the mold, that the open end portion and portions of the body portion close thereto have a smooth curved surface. Accordingly, the wall thickness of the funnel 4 is decreased by modifying the outer surface shape of a portion of the body 9 close to the yoke portion 6 without decreasing the wall thicknesses of the open end portion 8 and the portions close thereto.

In that case, a “flange portion” 14 having a thicker wall than the body portion 9 is formed around the entire periphery of the open end portion 8 on the outer surface. Even when the height Hᵣ of the flange portion 14 in the direction of the bulb axis A is not extremely large, strength required for withstanding the vacuum tensile stress at the sealing portion can be ensured. The second decreasing method to modify the outer surface shape is more preferable than the first decreasing method to modify the inner surface shape from the viewpoint that the second decreasing method can provide a drastic reduction in weight without creating the problems of mold release and a fall in rigid due to the reduction in the wall thickness of the open end portion as stated earlier.

However, when the outer surface of the body portion 9 is thinned around the entire periphery of the funnel 4 as stated earlier, portions of the body portion 9 at the diagonal positions are also thinned, causing a problem that the rigidity in the vicinity of the corner portions 13 of the open end portion 8 lowers as stated earlier.

The strength reduction of the funnel 4 caused by the rigidity fall of the corner portions 13 not only increases the probability of fracture during conveyance but also leads to a decrease in anti-implosion properties of the cathode ray tube. Additionally, when a corner portion 13 has a defect, such as a chip or a crack, the defect may become a source of fracture since a temperature difference, which is caused when the funnel 4 and the panel 1 are maintained at a high temperature and are subjected to evacuation after sealing to the panel to the funnel, may be generated to produce fracture, starting at the defect.

The funnel is produced by subjecting a mass of molten glass (hereinbelow, referred to as the glass gob) to press molding. Since the glass gob flows toward the respective corner portions from portions around the corner portions, the glass gob takes an extremely complicated motion to gather from various directions at the corners in the mold. When the mold has a step or a bent portion at a corner, there have been created problems that the glass gob is prevented from freely flowing, and mixing of a foreign substance or formation of trapped air is introduced.

### SUMMARY OF THE INVENTION

The present invention is provided in consideration of the problems stated earlier. It is an object of the present invention to provide a funnel for a cathode ray tube capable of reducing the weight of the funnel without lowering the rigidity of a corner portion of the funnel and portions of the funnel close thereto, and avoiding fracture in a conveyance process during production, and a cathode ray tube utilizing the funnel.

In order to the object, the present invention provides a glass funnel for a cathode ray tube, comprising an open end portion having long sides, short sides and corner portions; a neck portion for housing an electron gun therein; a yoke portion for mounting a deflection coil thereto; and a body portion extending between the open end portion and the yoke portion; characterized in that the long or short sides of the open end portion or the long and short sides of the open end portion have flange portions formed thereon, and the corner portions have no flange portion formed thereon.

It is preferable that the glass funnel for a cathode ray tube satisfies the formulas of 0.45≦T_{CB1}/T_{S}≦0.62 and 0.45≦T_{CB2}/T_{S}≦0.62, wherein H_{B} is defined as a length from a seal edge to a yoke edge as a boundary between the body portion and the yoke portion in a direction parallel to a bulb axis; a point on an outer surface of the body portion, which is located at a position away from a center of a long side of the seal edge toward the neck portion by H_{B}/2 in the direction parallel to the bulb axis, is defined as a long side body portion center; and a point on an outer surface of the body portion, which is located at a position away from a center of a short side of the seal edge toward the neck portion by H_{B}/2 in the direction parallel to the bulb axis, is defined as a short side body portion center; T_{CB1} is a wall thickness of the body portion at the long side body portion center; T_{CB2} is a wall thickness of the body portion at the short side body portion center; and T_{S} is a wall thickness of the seal edge. The present invention also provides a cathode ray tube characterized in that a glass funnel of a glass bulb as an envelope is the glass funnel for a cathode ray tube defined earlier.

### BRIEF DESCRIPTION OF THE DRAWING FIGURES

A more complete appreciation of the invention and many of the attendant advantages thereof will be readily obtained as the same becomes better understood by reference to the following detailed description when considered in connection with the accompanied drawings, wherein:

FIG. 1 is a schematic view of an example, wherein the body portion of a funnel has an outer surface shape modified so as to be thinned and to be provided with flange portions;

FIG. 2 is a schematic view of an example, wherein the body portion of a funnel is neither thinned nor provided with a flange portion;

FIG. 3 is a schematic view showing a part of a funnel in section;

FIG. 4 is a schematic view showing the center of the body portion of the funnel and a partial cross-section of the funnel;

FIG. 5 is a schematic view of a pendulum test device;

FIG. 6 is a schematic view of a part of a cathode ray tube in section;

FIG. 7 is a schematic view showing an open end portion of the funnel; and

FIGS. 8(a) and 8(b) are schematic views showing examples, in each of which the body portion of a funnel has an inner surface shape modified to be thinned.

### DETAILED DESCRIPITION OF THE PREFERRED EMBODIMENTS

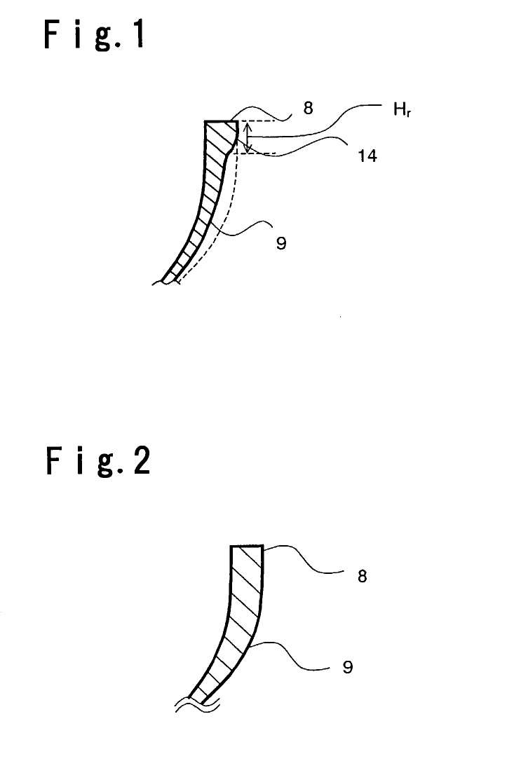

Now, the present invention will be described in detail. In the following explanation, the glass funnel for a cathode ray tube is simply referred to as the funnel. FIG. 1 is a view of a portion of the funnel 4 close to an open end portion, which shows a section passing through long sides 11 or short sides 12. FIG. 2 is a cross-sectional view of a portion of the funnel 4 close to the open end portion taken along a section passing through corner portions 13.

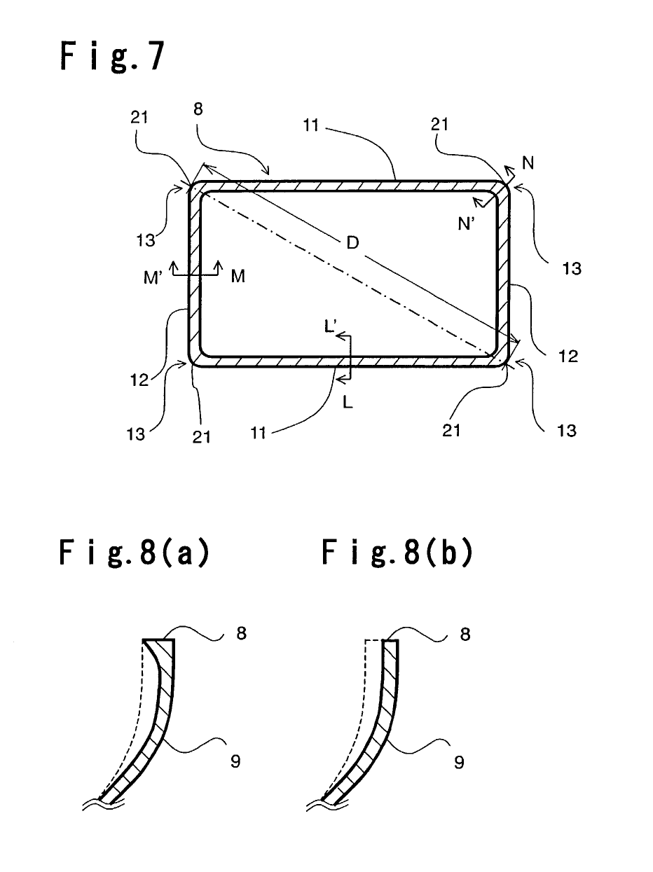

The open end portion 8 of the funnel 4 is formed in a substantially rectangular shape as shown in FIG. 7 and includes four of the corner portions 13, and the long sides 11 and the short sides 12 connecting the corner portions 13. In the present invention, each of the corner portions refers to a region ranging from a first position where when a diagonal axis is turned toward the direction of a long side 11 about the bulb axis by 4 deg., an imaginary liner line that was aligned with the diagonal axis before turning intersects the outer periphery of the open end portion 8 to a second position where when the diagonal axis is turned toward the direction of a short side 12 about the bulb axis by 4 deg., the imaginary liner line intersects the outer periphery of the open end portion 8. More specifically, the long sides 11 and the short sides 12 in the present invention mean portions of the open end portion having a substantially rectangular shape except for the corner portions 13. The corner portions 13 may be formed in a shape defined by two crossing line segments or a curved shape with a radius. The long sides 11 and the short sides 12 may be formed in a liner shape or a gently curved shape having a large curvature radius.

The shape wherein the long or short sides of the open end portion or the long and short sides of the open end portion have flange portions formed thereon means a shape wherein the open end portion 8 projects in outward directions (directions away form the bulb axis A) to be flanged by modifying an outer surface shape of the body portion 9 so as to thin the body portion as shown in FIG. 1 in a section in parallel with the bulb axis and passing through the long sides 11 and/or the short sides 12. In the present invention, the portions in the projected form at the open end portion 8 are referred to as flange portions 14. As shown in FIG. 1, the outer surface of the funnel with a flange portion 14 has a sectional shape extending from the open end portion 8 to the body portion 9 provided with a convex curved line projecting outwardly (in a direction away from the bulb axis), a convex curved line projecting inwardly (in a direction directing to the bulb axis) beyond a first inflection point and another convex curved line projecting outwardly beyond a second inflection point. In the present invention, the portion that extends from the edge of the open end portion 8 to the second inflection point forms a flange portion 14.

The phrase “the corner portions have no flange portion formed thereon” means a shape wherein the outer surface shape of the body portion 9 is not modified to prevent the body portion from being thinned, the open end portion has no flange portion as stated earlier, and the body portion has a substantially smooth curved profile as shown in FIG. 2 in a section in parallel with the bulb axis A and passing through corner portions 13 of the open end portion of the funnel 4.

The funnel according to the present invention can make the body portion thinned to reduce the weight by providing the flange portions to the long or short sides of the open end portion or the long and short sides of the open end portion and forming the corner portions so as to have no flange portion. Simultaneously, the funnel can resolve the problem of a fall in rigidity at the corner portions and allow a glass gob to smoothly flow during funnel production.

It is preferable from the viewpoint of preventing excessive concentration of vacuum tensile stress at the sealing portion that the height Hr of the flange portions 14 in the direction of the bulb axis A is 10 mm or longer.

It is preferable that the flange portions are provided in a region occupying less than 60% of the distance between apexes of the opposite corner portions on the long sides or the short sides. The distance between the apexes of the opposite corner portions means the distance between the apex of a corner portion and the apex of another corner portion. The apex of a corner portion means a position at which the outer size of the substantially rectangular open end portion is at the maximum. In FIG. 7, the apexes of the corner portions are indicated by reference numeral 21.

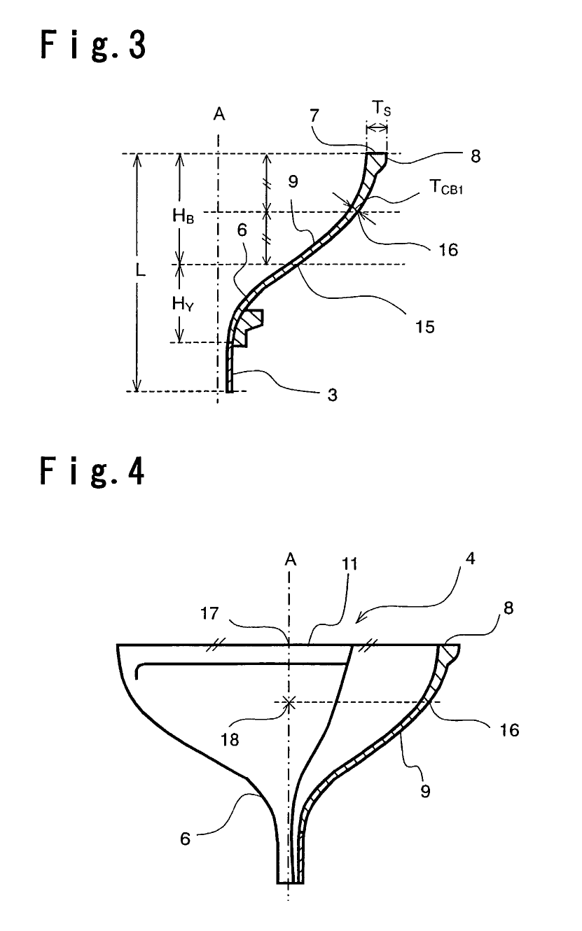

It is preferable that the funnel is formed in such a shape that a wall thickness T_{CB1} of the body portion at the long side body portion center, a wall thickness T_{CB2} of the body portion at the short side body portion center and a wall thickness T_{S} of the seal edge satisfy the relationships of T_{CB1}/T_{S}≦0.62 and T_{CB2}/T_{S}0.62. When the values of T_{CB1}/T_{S} and T_{CB2}/T_{S} are beyond 0.62, the weight of the funnel increases, making desired weight reduction impossible. When the values of T_{CB1}/T_{S} and T_{CB2}/T_{S} are smaller than 0.45, there is created a problem that it becomes difficult to carry out mold forming or it becomes impossible to carry out mold forming in the case of the funnel having an unsuitable size. Even when it is possible to carry out mold forming, it becomes impossible to withstand the tensile stress caused at the body portion when the inner portion of the cathode ray tube is evacuated. From this viewpoint, it is preferable that the values of T_{CB1}/T_{S} and T_{CB2}/T_{S} are properly set in the range of 0.45 to 0.62 in consideration of the shape of the funnel, a stress distribution or another factor. It is more preferable from easy mold forming that the values satisfy the formulas of 0.5≦T_{CB1}/T_{S} and 0.5≦T_{CB2}/T_{S}. It is more preferable from the viewpoint of further weight reduction that the values satisfy the formulas of T_{CB1}/T_{S}≦0.56 and T_{CB2}/T_{S}≦0.58. Now, explanation of the wall thickness of the body portion centers will be made, referring to FIG. 3 and FIG. 4 showing sectional views of a part of the funnel.

In the present invention, the position on the outer surface of the funnel that is right in the middle of the length between a seal edge 7 and a yoke portion edge 15 in the direction of the bulb axis A as shown in FIG. 3 is referred to as the body portion center 16.

The yoke portion end 15 is the position that is the boundary between a yoke portion 6 and the body portion 9. When the yoke portion 6 is a conical funnel, this position is called a “yoke edge”, a “true-circular edge”, or a “top of round” by persons having ordinary skill in the art. That position is the closest position to the open end portion 8 among positions that have true-circular contour of outer surfaces in the sectional view of the funnel 4 in a direction perpendicular to the bulb axis A. When the yoke portion 6 is a substantially quadrangular pyramidal funnel, that position is the position that curved lines having different radii of curvature and/or centers of curvature contact each other.

The position where the line that extends from the center 17 of a long side 11 of the open end portion 8 along the surface of the body portion 9 in the direction of the bulb axis reaches the body portion center 16 as shown in the front view and/or a partial sectional view of FIG. 4 as viewed from the long side of the funnel 4 is referred to as a long side body portion center 18. Likewise, the position where the line that extends from the center of a short side 12 along the surface of the body portion 9 in the direction of the bulb axis reaches the body portion center 16 is referred to as a short side body portion center. The position where the line that extends from a point on a corner portion having the largest diagonal size along the surface of the body portion 9 in the direction of the bulb axis reaches the body portion center 16 is referred to as a diagonal body center.

In other words, when the length from the seal edge 7 to the yoke edge 15 as the boundary between the body portion 9 and the yoke portion 6 in the direction of the bulb axis is H_{B}, the point on the outer surface of the body portion that is located at a position away from a long side center of the seal edge 7 toward the neck portion 3 by H_{B}/2 in the direction of the bulb axis is the long side body portion center 18. The point on the outer surface of the body portion that is located at a position away from the center of a short side of the seal edge toward the neck portion by H_{B}/2 in the direction parallel to the bulb axis is the short side body portion center.

Although the wall thickness of the body portion 9 at a long side body portion center 18 is the liner distance (length) that extends from the long side body portion center 18 on the outer surface of the body portion to the inner surface of the body portion, the wall thickness can have different values, depending on which section of the funnel is selected. In the present invention, the wall thickness at the section wherein the distance (length) from the a long side body portion center 18 on the outer surface of the body portion to the inner surface of the body portion has the shortest one (the minimum value) is referred to as the wall thickness T_{CB1} of the body portion at the long side body portion center. The wall thickness T_{CB2} of the body portion at a short side body portion center, and the wall thickness T_{CB3} of a diagonal body center are also defined by using the short side body portion center and the diagonal body center as starting points. The wall thickness of the open end portion T_{S} is the wall thickness of the end surface of the open end portion 8 in the direction perpendicular to the bulb axis A and is substantially equal in the entire periphery.

When the values of T_{CB1}/T_{S} and T_{CB2}/T_{S} are beyond 0.62 in the present invention, a sufficient decrease in the wall thickness cannot be provided, creating a problem that the funnel cannot reduce the weight in comparison with the conventional funnels. From this viewpoint, the preferable range is not higher than 0.62. When the funnel have a shape in the preferable range, the funnel can be provided as being thinned and lightweight and having sufficient rigidity without increasing the difficulty in mold forming. When a cathode ray tube is produced by use of a funnel having such a shape, the generation of a crack or a fracture can be prevented in the production process.

### EXAMPLES

Now, an embodiment of the present invention will be described in detail based on examples. The funnels in the examples stated later are all formed in the shape defined in the following Table 1. The “Open End Portion Diagonal Size” means the diagonal length (D) of the substantially rectangular open end portion (see FIG. 7), the “Funnel Entire Length” means the length (L) from the open end of the open end portion 8 to the end of the neck portion 3 in the direction of the bulb axis, (see FIG. 3), the “Length from Open End Portion to Yoke Portion End” means the length (H_{B}) from the open end of the open end portion 8 to the yoke portion end 15 in the direction of the bulb axis (see FIG. 3), and the “Yoke Portion Length” means the length (H_{Y}) from the sealed portion between the neck portion 3 and the yoke portion 6 to the yoke portion end 15 in the direction of the bulb axis (see FIG. 3).

TABLE 1

| | | |
|---|---|---|
| Aspect Ratio | 4:3 | |
| Deflection Angle | 90 | deg. |
| Open End Portion Diagonal Size (D) | 439.96 | mm |
| | (17 | in.) |
| Funnel Entire Length (L) | 330.39 | mm |
| Length from Open End Portion to Yoke | 114.97 | mm |
| Portion End (H_{B}) | | |
| Yoke Portion Length (H_{Y}) | 88.42 | mm |

The following test was conducted to evaluate impact properties during conveyance in a production process, using funnels having different wall thicknesses in respective portions as shown in Examples 1 to 4. The central section of a long side portion, the central section of a short side portion and the section of a corner portion are the respective sectional shapes of the funnel, which are viewed in the directions of L-L′, M-M′ and N-N′ in FIG. 7.

### Example 1 as an Example

The funnel of Example 1 was formed in such a shape that (1) the wall thicknesses of the body portion on the long side portions and the short side portions were decreased from the outer surface, (2) the body portion was not thinned at the diagonal positions with a conventional wall thickness kept, and (3) the open end portion kept a conventional wall thickness in the entire periphery. As a result, each of the long side portions and the short side portions had a flange portion, as viewed in section, in the region, which occupied 91% of the distance between the opposite corner portion apexes. On the other hand, the corner portions had smooth curved surfaces without a flange portion.

### Example 2 as a Comparative Example

The funnel of Example 2 was formed in such a conventionally designed shape, without being thinned, that (1) the wall thickness of the body portion on the long side portions, the short side portions or the diagonal positions was not decreased, keeping a conventional wall thickness, and (2) the open end portion kept a conventional wall thickness in the entire periphery. As a result, the long side portions, the short side portions or the corner portions had smooth curved surfaces without a flange portion in the entire periphery.

### Example 3 as a Comparative Example

The funnel of Example 3 was formed in such a shape that (1) the wall thicknesses of the body portion on the long side portions, the short side portions and the diagonal portions were decreased from the inner surface, (2) the open end portion was thinned in the entire periphery, and (3) the outer surface was the same shape as that of the funnel of Example 2. As a result, the funnel had a smooth section without a flange portion in the entire periphery, and the body portion and the open end portion were both thinned.

### Example 4 as an Example

The funnel of Example 4 was formed in such a shape that (1) the wall thicknesses of the body portion on the long side portions and the short side portions were decreased from the outer surface, (2) the wall thicknesses of the body portion on the diagonal positions were decreased from the outer surface, and (3) the open end portion kept a conventional wall thickness in the entire periphery. As a result, the open end portion had the entire periphery formed with a flange portion as viewed in section.

The outer peripheral shape of the open end portions and the wall thicknesses of the open end portions in the funnels of Example 1 to Example 4 are shown as the following Table 2:

TABLE 2

| | | Wall Thickness T_{S} |
|---|---|---|
| | | of Open End |
| | Shape of Open End Portion | Portion |
| Example 1 | Each of the long side | 9.2 mm |
| | portions and the short side | |
| | portions had a flange | |
| | portion in the region, | |
| | which occupied 91% of the | |
| | distance between the | |
| | opposite corner portion | |
| | apexes. There was no | |
| | flange portion on the | |
| | corner portions. | |
| Example 2 | There was no flange portion | 9.2 mm |
| | in the entire periphery. | |
| Example 3 | There was no flange portion | 8.0 mm |
| | in the entire periphery. | |
| Example 4 | A flange portion was formed | 9.2 mm |
| | in the entire periphery. | |

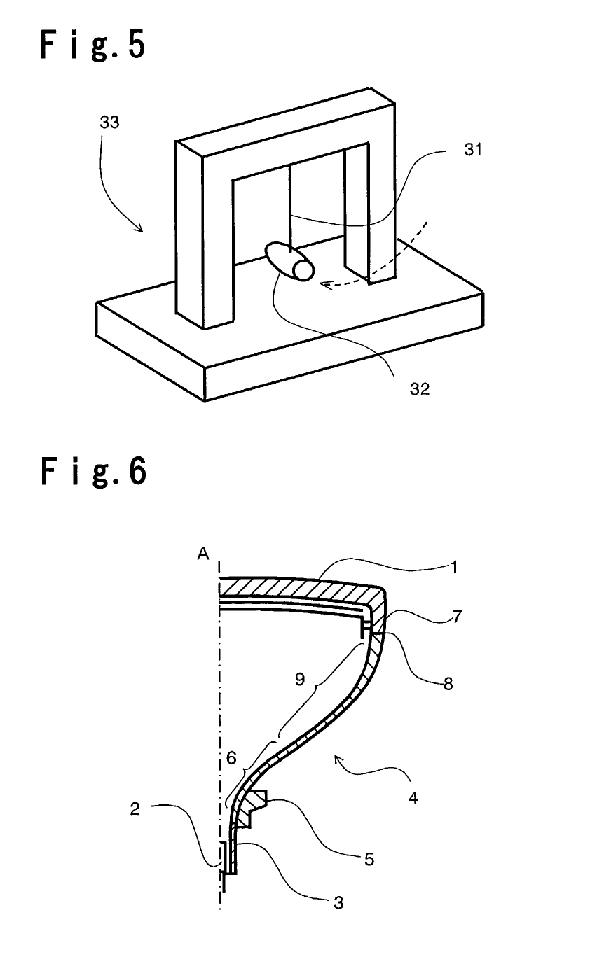

The funnels thus formed were measured with respect to the respective masses and the probabilities of breakage. As the fracture test system, was used a pendulum test device 33, wherein an arm 31 having a length of 30 cm had a leading edge provided with an iron missile having a diameter of 20 mm and a mass of 65 g as shown in FIG. 5. Each of the funnels was set so that a corner portion of the open end portion was located at the lowest position of the missile 32. Each of the funnels was supported from the side opposite to the hitting side of the missile 32 so that each of the funnels was prevented from shifting by impact when the missile 32 was hit. The impact energy to each of the funnels from the missile 32 was set at 8.0×10⁻²J. The evaluation was conducted by counting the number of funnels that were broken or fractured (referred as to destruction). The results are shown in the following Table 3:

TABLE 3

| | Example 1 | Example 2 | Example 3 | Example 4 |
|---|---|---|---|---|
| Flange Portion on | Yes | No | No | Yes |
| Long Side Portion | | | | |
| Flange Portion on | Yes | No | No | Yes |
| Short Side | | | | |
| Portion | | | | |
| Flange Portion on | No | No | No | Yes |
| Corner Portion | | | | |
| T_{CB1}/T_{S} | 0.49 | 0.65 | 0.66 | 0.56 |
| T_{CB2}/T_{S} | 0.52 | 0.65 | 0.70 | 0.60 |
| Mass of Funnel | 2.8 | 3.1 | 3.0 | 2.8 |
| (kg) | | | | |
| Probability of | 0/10 | 0/10 | 6/10 | 2/5 |
| Destruction | | | | |
| (Number of | | | | |
| Destructed/Number | | | | |
| of Samples) | | | | |

The results show that the funnel of Example 3, which had the inner shape of the body portion modified so as to be thinned and the wall thickness of the open end portion decreased in comparison with the funnel of Example 2 having a conventional shape without subjected to weight reduction, had an extremely high probability of destruction on the ground that the wall thickness of the open end portion was decreased, though the weight was merely decreased by about 3%.

The results show that the funnel of Example 4, which had the wall thicknesses of the body portion on the long side portions and the short side portions decreased from the outer surface and the wall thickness of the open end portion on the diagonal positions decreased to have a flange portion in the entire periphery, had a high probability of destruction, though the weight was decreased by about 10% in comparison with the funnel of Example 2.

The results reveal that the funnel of Example 1, which was formed to have flange portions only on the long side portions and the short side portions by decreasing only the wall thicknesses of the body portion on the long side portions and the short side portions from the outer surface without decreasing the wall thickness of the open end portion in comparison with the funnels of Examples 3 and 4, and which satisfied the formulas of 0.45≦T_{CB1}/T_{S}0.62 and 0.45≦T_{CB2}/T_{S}≦0.62, was able to reduce the weight by about 10% in comparison with the funnel of Example 2, that no destruction occurred at the corner portions, and that there was almost no drop in strength.

The funnel according to the present invention can offer advantages in that not only weight reduction is obtained but also the probability of breakage or fracture during conveyance in the production process can be deceased without lowering the rigidity of the corner portions, which are weak at mechanical impact. The funnel according to the present invention can also decrease the probability of breakage or fracture in a thermal treatment, such as an evacuation step in production of a cathode ray tube, an implosion test or the like. The funnel according to the present invention can restrain problems in mold forming from being created by not providing a flange portion to the corner portions having a complicated shape.

The funnel according to the present invention can be utilized to provide a lightweight cathode ray tube having a high safety.

What is claimed is:

1. A glass funnel for a cathode ray tube, comprising an open end portion having long sides, short sides and corner portions; a neck portion for housing an electron gun therein; a yoke portion for mounting a deflection coil thereto; and a body portion extending between the open end portion and the yoke portion;
wherein the long or short sides of the open end portion or the long and short sides of the open end portion have flange portions formed thereon, and the corner portions have no flange portion formed thereon.

2. The glass funnel for a cathode ray tube according to claim 1, wherein when H_{B} is defined as a length from a seal edge to a yoke edge as a boundary between the body portion and the yoke portion in a direction parallel to a bulb axis, a point on an outer surface of the body portion, which is located at a position away from a center of a long side of the seal edge toward the neck portion by H_{B}/2 in the direction parallel to the bulb axis, is defined as a long side body portion center, and a point on an outer surface of the body portion, which is located at a position away from a center of a short side of the seal edge toward the neck portion by H_{B}/2 in the direction parallel to the bulb axis, is defined as a short side body portion center,
when T_{CB1} is a wall thickness of the body portion at the long side body portion center, T_{CB2} is a wall thickness of the body portion at the short side body portion center, and T_{S} is a wall thickness of the seal edge,
the following formulas are satisfied:
0.45≦T_{CB1}/T_{S}≦0.62 and 0.45 T_{CB2}/T_{S}≦0.62

3. A cathode ray tube including a glass funnel of a glass bulb as an envelope, the glass funnel being the glass funnel for a cathode ray tube according to claim 1.

4. A cathode ray tube including a glass funnel of a glass bulb as an envelope, the glass funnel being the glass funnel for a cathode ray tube according to claim 2.
